(19) United States
(12) Patent Application Publication
(10) Pub. No.: US 2014/0208384 A1
(43) Pub. Date: Jul. 24, 2014

(54) SYSTEM AND METHOD FOR MANAGING, CONTROLLING AND ENABLING DATA TRANSMISSION FROM A FIRST DEVICE TO AT LEAST ONE OTHER SECOND DEVICE, WHEREIN THE FIRST AND SECOND DEVICES ARE ON DIFFERENT NETWORKS

(71) Applicant: Push Science, Toronto (CA)

(72) Inventors: Artin Youssefian, Toronto (CA); Ramsey Tabbara, Toronto (CA)

(73) Assignee: Push Science, Toronto (CA)

(21) Appl. No.: 14/099,950

(22) Filed: Dec. 7, 2013

Related U.S. Application Data
(60) Provisional application No. 61/755,407, filed on Jan. 22, 2013.

(51) Int. Cl. H04L 29/06

(52) U.S. Cl. CPC H04L 63/0884
USPC 726/3

(57) ABSTRACT

A computer-implemented method of pairing at least two micro-processing devices (a primary device on a first network and a secondary device on a second network which may be different from the first network) comprises a device pairing server for the purpose of at least one of direct data exchange and indirect data exchange, between the devices.

### CROSS REFERENCE TO RELATED APPLICATION

This application claims priority to U.S. Provisional Patent Application No. 61/755,407, entitled “SYSTEM AND METHOD FOR MANAGING, CONTROLLING AND ENABLING DATA TRANSMISSION FROM A FIRST DEVICE TO AT LEAST ONE OTHER SECOND DEVICE, WHEREIN THE FIRST AND SECOND DEVICES ARE ON DIFFERENT NETWORKS”, filed Jan. 22, 2013, which is hereby incorporated by reference herein in its entirety.

### FIELD OF THE INVENTION

This invention relates to improvements in the field of data sharing between devices over the internet.

### BACKGROUND OF THE INVENTION

The emergence of (particularly) mobile devices as the leading personal communications device has led to their attractiveness as a potentially lucrative data platform for business transactions. Applications on the mobile phones widely use push and pull technology. Push technology, or server push, describes a style of Internet-based communication where the request for a given transaction is initiated by a publisher or central server. It is contrasted with pull technology, where the request for the transmission of information is initiated by the receiver or client. Push services include synchronous conferencing, instant messaging, chat messages and Emails. Other uses are push enabled web applications including market data distribution (stock tickers), auctions, online betting and gaming, sport results, monitoring consoles and sensor network monitoring.

In contrast, pull technology or client pull is a style of network communication where the initial request for data originates from the client, and then is responded to by the server. Pull technology is effective and economical when advertising to open, unidentified potential customers worldwide.

Most web feeds, such as Really Simple Syndication (RSS) are technically pulled by the client. SMS (for example banking) services are operated using both push and pull messages. Typically push messages could be either mobile marketing messages or messages alerting an event which happens in the customer's bank account, such as a large withdrawal of funds from the ATM or a large payment using the customer's credit card.

Another type of push message is One-time password (OTPs). OTPs are a tool used by companies, particularly financial and banking service providers in the fight against cyber fraud. Instead of relying on traditional memorized passwords, OTPs are requested by consumers each time they want to perform transactions using the online or mobile commercial interfaces. When the request is received the password is sent to the consumer's phone via SMS. The password is expired once it has been used or once its scheduled life-cycle has expired.

The secure transmission of data via internet connected devices is revolutionizing the fields of sales, marketing and customer relationship management (CRM). Such transmission is not without challenges particularly when such devices are connected to the internet via different networks.

It is an object of the present invention to obviate or mitigate at some of the above disadvantages.

### SUMMARY OF THE INVENTION

The present invention provides, in one aspect, a computer-implemented method of pairing at least two micro-processing devices (a primary device on a first network and a secondary device on a second network which may be different from the first network) via a device pairing server for the purpose of at least one of direct data exchange and indirect data exchange, between the devices, which comprises a) the primary device, desiring one of direct data exchange and indirect data exchange with the secondary device, acquiring a first authentication code; b) the secondary device, desiring one of direct data exchange and indirect data exchange with the primary device acquiring a second authentication code; c) the primary device and the secondary device using respective authentication codes, which may be the same, to access at least one of a web site, web-service, mobile application of the device pairing server and upon entering respective authentication codes linking the primary device with the secondary device via the device pairing server; wherein authentication codes are requested, acquired and exchanged by at least one of the following arrangements:
i. primary device acquires authentication code from the device pairing server and transmits authentication code to secondary device;
ii. secondary device acquires authentication code from the device pairing server and transmits authentication code to primary device;
iii. both primary device and secondary device acquire the same authentication code from the device pairing server;
iv. the primary device acquires the authentication code from a third device which is recognized by the device pairing server and transmits authentication code to secondary device;
v. the secondary device acquires the authentication code from a third device which is recognized by the device pairing server and transmits authentication code to primary device; and
vi. both primary device and secondary device acquire the same authentication code from a third device which is recognized by the device pairing server.

The present invention provides, in another aspect, a computer-implemented method of pairing at least two micro-processing devices (a primary device on a first network and a secondary device on a second network which may be different from the first network) via a device pairing server for the purpose of data exchange, which comprises a) the primary device, desiring data exchange with the secondary device, acquiring a first authentication code; b) the secondary device, desiring data exchange with the primary device acquiring a second authentication code; c) the primary device and the secondary device using respective authentication codes to access at least one of a web site or web-service of the device pairing server and upon entering respective authentication codes linking the primary device with the secondary device via the device pairing server; wherein both the primary device and the secondary device acquire respective authentication codes from a third device which is recognized by the device pairing server.

The present invention provides, in another aspect, a computer-implemented method of pairing at least two micro-processing devices (a primary device on a first network and a secondary device on a second network which may be different from the first network) for the purpose of data exchange, which comprises a) the primary device, desiring data exchange with the secondary device, requesting from a device pairing server an authentication code; b) the primary device receiving the authentication code and conveying the authentication code to the secondary device; the secondary device accessing a web service or an web-based interface of the device pairing server and entering the authentication code, therein linking the primary device with the secondary device via the device pairing server; c) the primary device and the secondary device accessing and sharing data through at least one direct data exchange and indirect data exchange.

The present invention provides, in another aspect, a non-transitory processor readable medium storing code representing instructions to cause a processor to pair at least two micro-processing devices (a primary device on a first network and a secondary device on a second network which is different from the first network) for the purpose of data exchange, said pairing comprising a primary device on a first network and a secondary device on a second network (which may be different from the first network) via a device pairing server for the purpose of data exchange, which comprises a) the primary device, desiring data exchange with the secondary device, acquiring a first authentication code; b) the secondary device, desiring data exchange with the primary device acquiring a second authentication code; c) the primary device and the secondary device using respective authentication codes to access at least one of a web site, web-service and mobile application of the device pairing server and upon entering respective authentication codes linking the primary device with the secondary device via the device pairing server; wherein at least one of the primary device and the secondary device acquires respective authentication code from a third device which is recognized by the device pairing server; and d) the primary device and the secondary device accessing and sharing data through at least one of direct data exchange and indirect data exchange.

The present invention provides, in another aspect a non-transitory processor readable medium storing code representing instructions to cause a processor to pair at least two micro-processing devices (a primary device on a first network and a secondary device on a second network which is different from the first network) for the purpose of data exchange, said pairing comprising a) the primary device, desiring data exchange with the secondary device, requesting from a device pairing server an authentication code; b) the primary device receiving the authentication code and conveying the authentication code to the secondary device; the secondary device accessing a web service or an web-based interface of the device pairing server and entering the authentication code, therein linking the primary device with the secondary device via the device pairing server; c) the primary device and the secondary device accessing and sharing data through at least one of direct data exchange and indirect data exchange.

The present invention provides, in another aspect a system comprising:
a) a primary micro-processing device (primary device) at a first location and connected to the internet via a first network, said primary device being desirous of at least one of i) synchronously and/or asynchronously transmitting audio and/or video and/or other data and content to a secondary micro-processing device and ii) synchronously and/or asynchronously transmitting a pointer to the secondary device, said pointer representing at least one of: third party content which is downloaded by the secondary device; content on the device pairing server which is downloadable by the secondary device and third party content populating a template on a device pairing server, which is downloadable by the secondary device;
b) the secondary micro-processing device (secondary device) at a second location, which may be the same at the first location, and connected to the internet via a second network which may be different from the first network, said secondary device being desirous of at least one of i) synchronously and/or asynchronously transmitting audio and/or video and/or other data and content to the primary micro-processing device and ii) synchronously and/or asynchronously transmitting a pointer to the primary device, said pointer representing at least one of: third party content which is downloadable by the primary device; content on the device pairing server which is downloadable by the primary device and third party content populating a template on a device pairing server, which is downloadable by the primary device; and
c) the device pairing server comprising a processor configured: i) in response to a request from an initiating device, to generate an authentication code ii) to receive input of such authentication code from a primary device and secondary device via at least one of a web site, web service or mobile application interface, wherein said primary device and secondary device acquires the authentication code from the initiating device and iii) to undertake at least one of the following actions: acting as a data exchange conduit between the primary device and the secondary device after input of authentication code from the primary device and the secondary device and verification of each authentication code; acting as a conduit between the primary device and the secondary device after input of authentication code from the primary device and the secondary device and verification of each authentication code in order to convey a pointer from at least one of primary device to secondary device and secondary device to primary device, wherein said pointer represents at least one of: third party content which is downloadable by/accessible to a device; content on the device pairing server which is downloadable by/accessible to a device and third party content populating a template on a device pairing server, which is downloadable by/accessible to a device; defining the parameters of the secure communications between the primary device and the secondary device; accessing and sharing data between the primary device and the secondary device through at least one direct data exchange and indirect data exchange; recalling data sent to the secondary device; recalling data sent to the primary device; recording details of pairing sessions between the primary device the secondary device; tracking requests made by the primary device and the secondary device; managing the transmission of third party media to the primary device and to the secondary device; controlling primary device relative to the secondary device; and controlling secondary device relative to the primary device and controlling security of data exchanged between the primary device and the secondary device.

The present invention provides, in another aspect, a device pairing server comprising a processor configured: i) in response to a request from an initiating device, to generate an authentication code ii) to receive input of such authentication code from a primary device and secondary device via at least one of a web site, web service or mobile application interface, wherein said primary device and secondary device acquire the authentication code from the initiating device and iii) to undertake at least one of the following actions: acting as a data exchange conduit between the primary device and the secondary device after input of authentication code from the primary device and the secondary device and verification of each authentication code; acting as a conduit between the primary device and the secondary device after input of authentication code from the primary device and the secondary device and verification of each authentication code in order to convey a pointer from at least one of primary device to secondary device and secondary device to primary device, wherein said pointer represents at least one of: third party content which is downloadable by/accessible to a device; content on the device pairing server which is downloadable by/accessible to a device and third party content populating a template on a device pairing server, which is downloadable by/accessible to a device; defining the parameters of the secure communications between the primary device and the secondary device; accessing and sharing data between the primary device and the secondary device through at least one direct data exchange and indirect data exchange; recalling data sent to the secondary device; recalling data sent to the primary device; recording details of pairing sessions between the primary device the secondary device; tracking requests made by the primary device and the secondary device; managing the transmission of third party media to the primary device and to the secondary device; controlling primary device relative to the secondary device; and controlling secondary device relative to the primary device and controlling security of data exchanged between the primary device and the secondary device.

The present application provides, in another aspect, an interface on a microprocessing device which enables communication on a network with a device pairing server and which enables synchronous and asynchronous transference of data from the device to at least one other device via the device pairing server.

The device pairing server of the present invention enables multiple computers or microprocessor devices (for example, SmartPhones, tablets, smart TV's etc. . . . ) to connect to one another (via “virtual pairing”) through completely independent network (internet, intranet, cloud) connections. The purpose of pairing is to enable at least one device to securely push data (for example, multimedia content) directly or indirectly, synchronously or asynchronously, to another device or devices or to communicate various commands between devices simply all without the necessity or requirement of “direct” device to device communication. This is enabled by the linking of the otherwise unlinked devices via a device pairing server. It is to be understood that neither the device wishing to “push” data nor the “recipient” device need be registered by the device pairing server in order for the device pairing server to engage in a conduit role, between the two devices. What is required is that the devices be “paired” by an authentication code or codes. In one aspect, a first device wishing to push data to a second device is registered with the device pairing server and can request an authentication code which it may transmit to the second device (and which second device would then need to be input to device pairing server) in order for data to be exchanged between first device and second device via device pairing server.

In another aspect, neither first device nor second device are registered or otherwise recognized by device pairing server. However, an authentication code or codes may be conveyed, transmitted or broadcast to first device and the second device by a third “initiating” device. In this aspect, the initiating device is registered or otherwise recognized by device pairing server and is entrusted, upon request by initiating device, with authentication codes which may be conveyed, transmitted or broadcast to first device and the second device by then initiating device.

These and other advantages of the invention will become apparent throughout the present disclosure.

### BRIEF DESCRIPTION OF THE FIGURES

For simplicity and clarity of illustration, reference numerals may be repeated among the figures to indicate corresponding or analogous elements. The figures are listed below.

FIG. 1 illustrates a machine-implemented system that facilitates and/or effectuates the pairing of at least two micro-processing devices (a primary device on a first network and a secondary device on a second network which is different from the first network) for the purpose of data exchange there between;

FIG. 2 illustrates a machine-implemented system that facilitates and/or effectuates the pairing of at least two micro-processing devices (a primary device on a first network and a secondary device on a second network which is different from the first network) for the purpose of data exchange there between and wherein an initiating device facilitates the device pairing;

FIG. 3 illustrates a flow chart of the pairing sequence steps according to one aspect of the invention; and

FIG. 4 illustrates a flow chart of the data exchange sequence steps according to one aspect of the invention.

### DETAILED DESCRIPTION OF THE INVENTION

A method, system and device for management of communication between devices (preferably wherein at least one of said devices is a mobile device) are described herein. A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Unless specifically stated otherwise, it is appreciated that throughout the description, discussions utilizing terms such as “processing” or “computing” or “calculating” or “determining” or “displaying” or the like, refer to the action and processes of a data processing system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays with the applications described herein are not inherently related to any particular computer or other apparatus. Various general-purpose systems may be used with programs in accordance with the teachings herein, or it may prove convenient to construct more specialized apparatus to perform the required machine-implemented method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

An embodiment of the invention may be implemented as a method or as a machine readable non-transitory storage medium that stores executable instructions that, when executed by a data processing system, causes the system to perform a method. An apparatus, such as a data processing system, can also be an embodiment of the invention. Other features of the present invention will be apparent from the accompanying drawings and from the detailed description which follows.

### Terms

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

The term “device” and “mobile device” refer herein interchangeably to any computer, micro-processing device, personal digital assistant, SmartPhone other cell phone, tablets and the like. Preferably, devices comprise iPhones, iPADS, Apple computers or other devices operating via iOS or MAC operating systems, and devices operating on Android operating systems.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in a sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g. 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

“Web based interface”, “website” “mobile application” that are used herein to illustrate one means by which a device connects to the device pairing server (preferably a cloud server). It is to be understood, however, that while a device may use a web interface or website or mobile application during the authentication and data exchange process, it is also fully contemplated within the scope of the invention that the method may be operated within a native application (for example, a dedicated help module in an airline application). Therefore, in this and like cases, the user is not using a web interface during the interaction. Instead, the user is accessing a “web service” (as defined herein), meaning that the device connects to the device pairing server over the internet, but does not necessarily do so through a website or web interface to do so.

As used herein, “web service” sometimes called application services describes a standardized way of integrating Web-based applications using the XML, SOAP, WSDL, REST API's and UDDI open standards over an Internet protocol backbone. Web services share business logic, data and processes through a programmatic interface across a network. XML is used to tag the data, SOAP is used to transfer the data, WSDL is used for describing the services available and UDDI is used for listing what services are available. It is to be understood that Web services, which do not require the use of browsers or HTML allow parties to communicate data without intimate knowledge of each other's IT systems behind the firewall. Web services allow different applications from different sources to communicate with each other without time-consuming custom coding, because all communication is in XML. Web services are not tied to any one operating system or programming language. For example, Java can talk with Perl, Windows applications can talk with UNIX applications, etc. . . .

The system and method of the present invention provides that users at remote locations can, via live streaming, communicate (send text, video and audio data) in real time (synchronous communication) or in off-set time (asynchronous communication).

As used herein, synchronous communication means “direct” communication where the communicators are time synchronized. This conventionally means that all parties involved in the communication are “present” online or connected at the same time.

As used herein, asynchronous communication does not require that all parties involved in the communication to be present at the same time. Some examples are e-mail messages, discussion boards, blogging, and text messaging over mobile devices, for example over mobile/cellular devices. For example, a friend A sends friend B an e-mail message. Friend B later reads and responds to the message. There is a time lag between the time A sent the message and B replied, even if the lag time is short. Bulletin board messages can be added at any time and read at A and B's leisure; B does not read A's message as it is being created, and you can take as much time as you need to respond to the post. Asynchronous activities take place whenever recipients have the time to engage. Within the context of the present invention, data can be “pushed” at time X from one party for one or more of: downloading, viewing and responding by another party at time Y.

There are some key advantages to asynchronous engagement. For one thing, it enables flexibility. Participants can receive the information when it's most convenient for them. There is less pressure to act on the information or immediately respond in some way. People have time to digest the information and put it in the proper context and perspective.

As used herein, a server is preferably a physical computer or computers (a computer hardware system) dedicated to run one or more services to serve the needs of the users of devices remote from the server, on one or more networks.

The term “social media” as used herein is intended to be accorded broad meaning and include, at least social media outlet selected from the group consisting of Wikipedia, MySpace, Twitter, Facebook, Hootsuite, Flickr, YouTube, Pinterest, Google+, epinions, LinkedIn, Foursquare, WikiAnswers, weblogs, social blogs, and microblogs.

As used herein in a computer-implemented method of pairing at least two micro-processing devices (a primary device on a first network and a secondary device on a second network which may be different from the first network) via a device pairing server for the purpose of at least one of i) direct data exchange and ii) indirect data exchange, between the devices, “direct data exchange” comprises the step of device pairing service receiving data from primary device and transmitting such data to secondary device, or vice versa.

“Indirect indirect data exchange” comprises the step of device pairing server receiving, from the primary device a pointer and transmitting said pointer to the secondary device, the pointer representing at least one of:
i) third party content which is downloaded by the secondary device;
ii) content on the device pairing server which is downloaded by the secondary device;
iii) third party content populating a template on the device pairing server, which is downloaded by the secondary device.

As used herein “pointer” is a variable whose value is the address of another variable, i.e., direct address of the memory location. In other words, a pointer is a programming language data type whose value refers directly to (or “points to”) another value stored elsewhere a computer memory using its address. A pointer references a location in memory, and obtaining the value stored at that location is known as dereferencing the pointer. Many programming languages support some type of pointer.

It is most preferred within the scope of the method and system of the invention that data exchange between devices is via pointers, said device pairing server being a conduit for conveyance of one or more pointers from primary device to secondary (or target device or devices). A pointer is sent to the device pairing server and the server then sends that pointer to the target device. The target device then follows the pointers, which, in many cases, “point” to one or a combination of addresses or locations on third party servers and locations on the device pairing server. For example, the device pairing server may comprise a presentation template required to display the desired information on the target device, and a third party server comprises data that actually populates the template. It is to be understood that, in some aspects, data is passed/conveyed from the third party server to the device pairing server and in other aspects data is passed/conveyed directly from the third party server to the target device. So, for most applications of the method of the invention, data is retrieved from both the device pairing server and one or more third party servers. Even if text was entered in a particular form on a primary (source) device, it is preferred that the text is stored on one or both of the device pairing server and the third party server, and the secondary (target) device then retrieves the data from the server.

It is also to be clearly understood that data exchange and conveyance, while facilitated by the device to device, authenticated pairing over the device pairing server, is not then limited to data conveyance between primary device and secondary device. In fact, in many cases, it is third party data and content which is exchanged or transferred, in particular by source device providing device pairing server with “pointer” for use by the secondary device.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. Section 1.72(b). The title of the present application and headings of sections provided in the present application are for convenience only, and are not to be taken as limiting the disclosure in any way.

In a preferred mode, a pairing sequence is initiated when an “initiating device” (also referred to as “source device”) contacts a device pairing server (to which it is registered, recognized or otherwise in a trust relationship) and requests a unique authentication code for data transmission. The authentication code is then conveyed to the initiating or source device and the initiating device then enables transmission, conveyance or broadcasting of the authentication code (or codes) to one or more target devices, said target devices being desirous of data transfer and/or exchange. Target devices may be a primary device, a secondary device, a tertiary device and greater multiples.

In one aspect of the invention, an initiating device may be, for example, a kiosk display, tablet, Smartphone, Smart TV, laptop or desktop computer, or any device which is networked (to internet or intranet) and can transmit the authentication code.

In one aspect of the invention, an initiating device is in a registered, recognized or otherwise in a trust relationship with the device pairing server. In another aspect of the invention, at least one of the primary device, secondary device, tertiary device etc. . . . are in a registered, recognized or otherwise in a trust relationship with the device pairing server. In the event that at least one of the primary device, a secondary device, a tertiary device etc. . . . are in a registered, recognized or otherwise in a trust relationship with the device pairing server and can directly request an authentication code, it is not necessary that a separate initiating device requests an authentication code. However, it is to be understood that even though one or more of the primary device, secondary device, tertiary device etc. . . . are registered to, recognized by or otherwise in a trust relationship with the device pairing server, an initiating device may still be employed to i) request an authentication code (or codes) and ii) to transmit, convey or broadcast the authentication code (or codes) to one or more of a primary device, a secondary device, a tertiary device etc. . . . (“target devices”).

Within some aspects and embodiments of the invention, the primary device (which is desirous of transferring or pushing data to, for example, a secondary device or other target devices) is de facto, the initiating device which requests of the device pairing server an authentication code, which passes the authentication code to the secondary device or other target devices and which (post-engagement of secondary device, or other target devices with the device pairing server via the authentication code) transfers or pushes data to the secondary device or other target devices.

In some aspects of the invention, only the initiating device is registered to, recognized by or otherwise in a trust relationship with the device pairing server. In other aspects of the invention, a primary device is registered to, recognized by or otherwise in a trust relationship with the device pairing server. In other aspects of the invention, one or more target devices are registered to, recognized by or otherwise in a trust relationship with the device pairing server.

One example of an application of the method and system of the invention is a sales associate in a store using a tablet (the initiating or source device). The source device is pre-registered with a website or web service, operated via or associated with the device pairing server. The website, web service and/or mobile application is preferably a collection of web pages, hosted by the device pairing server or servers (for example the PushPair™ Service). The source device is “registered”, recognized or otherwise connected to the website or web service. The source device desires communication and data exchange with the target device (for example a SmartPhone used by the store customer) and to that end, requests an authentication code (referred to interchangeably herein as “code”) from the device pairing server. Source device receives the authentication code and then conveys this code to the target device. The target device need not have any previous connection to or be recognized by web service or website hosted by the device pairing server or servers or to the web server.

Conveyance of the code from the source device to the target device can occur by a plurality of means from low tech (for example, the salesperson viewing the code on his source device, verbally telling or showing the customer of the code and the customer manually entering such code into the target device via a user interface (for example a touch screen or keyboard) in or on such target device) to high tech (for example, optical scanning (for example, scanning a QR code that appears on the target device's screen), or using proximity based technologies like near field communications (NFC). In reality the conveyance of the code from the source device to the target device can be via any form of transmission between the devices (for example, infrared signal, audible signal, wireless/radio signal, light signal, other electro-magnetic signal, or via other networked or electronic means etc. . . . ) The authentication code may be captured by an audio and/or image capturing device such as a microphone and camera assembly formed as part of target device. In another preferred mode, audio and/or image capturing device is a microphone and camera assembly formed as part of a desk top computer and/or screen.

The target device must be internet connected and must have a means to “receive” the code from the source device as noted above. The target device accesses the web service or website or hosted by/associated with the device pairing server or servers or accesses the web service. No other registration is required by the target device other than entry of the code at the website or web service. There is no requirement that the target device share a network with the source device as long as both devices are internet connected so that the website hosted by/associated with the device pairing server or servers can be accessed, for the purpose of data exchange. In the example noted above the SmartPhone may be internet connected via a 3G network and the tablet by another unrelated network (for example, wireless internet in the store).

This way, the two devices (which may be side by side or in remote locations) are enabled for controlled and secure data exchange

So, a key aspect of the method and system of the present invention is to pair together two internet connected devices on different networks in a simple manner and in a way that the users of each device can interact with one another and complete a transaction using a device pairing server as the conduit. The method and system of the present invention may be implemented as a mobile commerce and customer service tool. As noted above, one scenario will be a customer service agent or store sales associate on a tablet/SmartPhone/computer (the “primary device”) who wants to connect with a customer's mobile device (the “secondary device”). The primary device may be at the same location as the customer or may be in a remote location. Either option is fully operable within the scope of the invention.

Another example of an application of the method and system of the invention comprises a device in a retail or business establishment being the initiating device. For example, an in store kiosk may be registered with the device pairing server and, upon request, issues an authentication code that both a sales associate and a customer input into their respective devices. The sales associate's device and the customer's device are enabled to engage in a data sharing session wherein the kiosk (original initiating device) plays no further role in the interaction or data exchange. In other words, in this aspect, the initiating device, which is “pre-registered” with and retrieves an authentication code or codes from the device pairing server, does not have to be one of the devices involved in the subsequent data share or data push sessions between the “paired” devices during the paired session.

In another aspect, a consumer is browsing a company's eCommerce website and adds items to his online shopping cart. The consumer does not need to be a registered customer with the company in order for engagement and data pushing to occur in accordance with the present invention. A data push or share in accordance with the method of the invention (also called a “PushPair” session) may be automatically started and the user is provided with an authentication code. In this embodiment, such a code is reserved for that specific session and cannot be used for any other customer interaction with that company. The data pairing server saves the state of the user's shopping cart and the session remains dormant until it is reactivated. If the user decides to continue his shopping session later via another sales channel (e.g. in the store), he can provide the code to a sales associate, the sales associate will enter it, and the session will sync with the sales associate's device. The same could occur if the user enters that code in a store kiosk. The preserved shopping cart will appear on the sales associate's device or on the kiosk. This way, there is provided a seamless transfer of saved data to other devices that may be present in another sales channels (call centre, kiosk, online website, sales associate, mobile application, etc). The authentication code acts as a unique identifier for users, and allows shoppers who are not existing customers, to retain their interactions with the company between channels. Companies may employ this tool as a customer acquisition solution.

In another aspect a customer and sales associate are desirous of starting a data share/data push session. The sales associate may encounter an issue with the customer's account that is outside of his knowledge base. At this point, the sales associate and using the system described herein may invite another colleague to join the session (using authentication codes) to view the customer's account and participate in the session. Alternatively, one sales associate or customer service representative may completely transfer the session to his colleague and drop out of the session, all the while having the identity of the customer tracked via the authentication code.

Another aspect of the present invention is a device pairing server which bridges two or more microprocessor devices on different networks to facilitate data transmission and security there between. More preferably, there the server is cloud-based and enables “pushing” of data to any device, whether a mobile device, a web application, a desktop computer, a laptop computer, such data relating (but not limited) to:
Social applications
Multiplayer Games
Group Chat Rooms
Event Broadcasting
Real-time Collaboration
Real-time Commerce
Customer Relations Management
Enhanced Desktop Software (push updates to users, trigger software to perform an action—like a backup, or a notification of an event occurring.)
Control Remote Devices (printers connectivity, televisions and other appliances, embedded systems controls)

Preferred components to implement the method of the present invention comprise at least:
1. Device Pairing Server and Service—to keep track of connected device requests, sessions between devices, permitted data exchange and all associated pairings. The service also manages connections to third party media and content services to transmit content to connected devices. More specifically, device pairing server undertakes at least one of the following actions: acting as a data exchange conduit between the primary device and the secondary device after input of authentication code from the primary device and the secondary device and verification of each authentication code; acting as a conduit between the primary device and the secondary device after input of authentication code from the primary device and the secondary device and verification of each authentication code in order to convey a pointer from at least one of primary device to secondary device and secondary device to primary device, wherein said pointer represents at least one of: third party content which is downloadable by/accessible to a device; content on the device pairing server which is downloadable by/accessible to a device and third party content populating a template on a device pairing server, which is downloadable by/accessible to a device; defining the parameters of the secure communications between the primary device and the secondary device; accessing and sharing data between the primary device and the secondary device through at least one direct data exchange and indirect data exchange; recalling data sent to the secondary device; recalling data sent to the primary device; recording details of pairing sessions between the primary device the secondary device; tracking requests made by the primary device and the secondary device; managing the transmission of third party media to the primary device and to the secondary device; controlling primary device relative to the secondary device; and controlling secondary device relative to the primary device and controlling security of data exchanged between the primary device and the secondary device.
2. Source Device—the source device (which may be, in some instances, the “primary device”) represents any connected device on which the pairing sequence has been initiated. The device could be a SmartPhone, tablet, computer, and even a smart TV. The device comprises the following an internet connection on any network to the device pairing server and related service and a means to receive a code from the device pairing server and to subsequently convey such code to the target device. Preferably, the source device comprises a display or some type of interface to show the status of the connection and to review and manipulate data to be “pushed” to server and to review and manipulate data received from the target device (via the server). Optionally, the source device comprises an output mechanism to pair with other devices, including, a screen, speaker, NFC mechanism.

The source device is preferably the “point of control” over the session.
3. Target Device—the target device makes a connection to the device pairing server, and conveys to the server a code which has been received from the target device by the source device. The code “bridges” the connection, on the server, of the source device and the target device allowing data to be exchanged therebetween. The target device may comprise a pairing input mechanism which can comprise, for example, an optical camera, barcode scanner, NFC scanner, microphone to detect audio ID's, or even a software/hardware keyboard to enter the authentication code.
4. Third-party Content & Services—third-party content and services may be used to supply content and services to the target and/or source device through the device pairing server and related service. The content can include images, video, audio, text, or any combination of these. Services can include social media sites, product or service catalogues, financial or billing related services, or any other personal or business information service that is able to display relevant content.

### Mobile Devices

Mobile devices and networking technologies have transformed many important aspects of everyday life. Mobile devices, such as smart phones, other cell phones, personal digital assistants, enterprise digital assistants, tablets and the like, have become a daily necessity rather than a luxury, communication tool, and/or entertainment center, providing individuals with tools to manage and perform work functions such as reading and/or writing emails, setting up calendaring events such as meetings, providing games and entertainment aspects, and/or store records and images in a permanent and reliable medium. The internet has provided users with virtually unlimited access to remote systems, information and associated applications.

As mobile devices and networking technologies have become robust, secure and reliable, ever more consumers, wholesalers, retailers, entrepreneurs, educational institutions, advocacy groups and the like are shifting paradigms and employing the these technologies to undertake business and create opportunities for meaningful engagement with users. It is within the backdrop that the system and method of the present invention was developed.

### In Operation

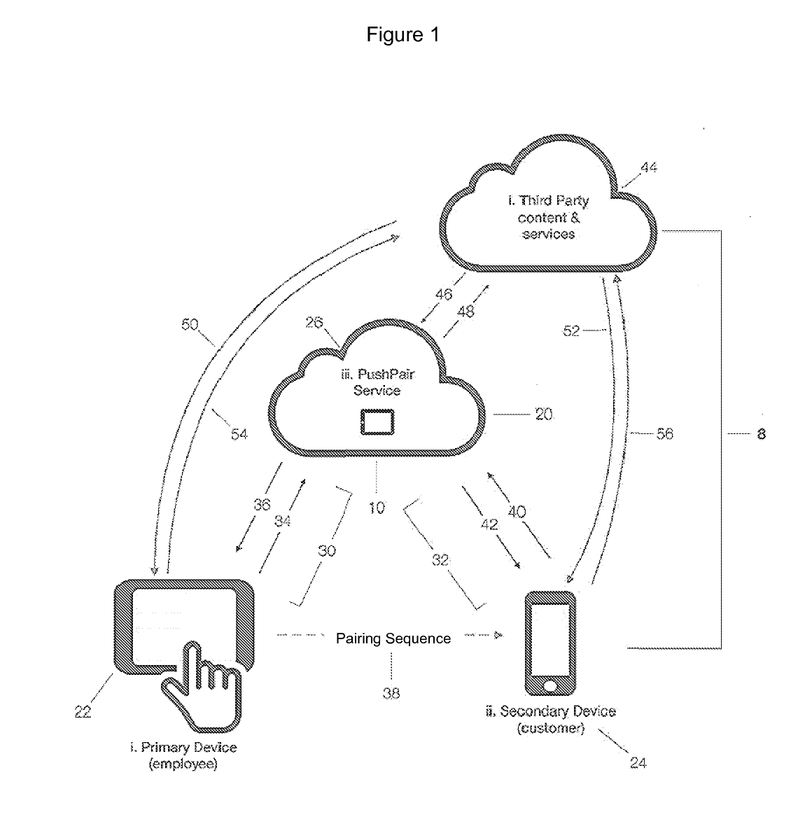

By way of example, FIG. 1 shows one embodiment of the use of the method and system of the present invention:

As seen in FIG. 1, the system and method according to the invention (shown generally at 8) are for use with a website 10 operated on a device pairing server 20, accessible over the Internet by a user of primary device 22 and a user of secondary device 24. The website 10 is one web page or more (a collection) of web pages, hosted on device pairing server 20 (which may comprise more than one server). Primary device 22 is connected to the Internet by network 30 and secondary device 24 is connected to the Internet by network 32, which is, this embodiment, a different network than 30.

A user of primary device 22 wishes to transmit to or “exchange data with” or “enable the transmission of data” to a user of secondary device 24. The users wish secure, easy and quick transmission of data and information. In some cases, data to “pushed” for viewing on interface of secondary device may be an identical web interface and content as viewed by user of primary device.

In one aspect, the primary device is operated by an employee of a business and is registered with website 10 to enable future “requests’ for codes to enable data transmission to secondary devices, which may be operated by customers/users of the business. In some cases, such a registration system may include obtaining information about the primary device, user of the device etc. . . . including one or more of names (business or personal), email address, geographic information, such as address, or country of residence, and the like. Once registered, a user of registered primary device 22 can log on to website 10 using a user name and password, which are provided by server 20 or selected by the user on registration. The user registered primary device 22 may also be provided a customized web page at website 10 at which they can upload and display content.

Server 20 has database 26 which stores the website, the content thereon, associated web pages, records about each device and the content, and information data to be transferred and exchanged. Website 10 may also provide a home web page.

Primary device 22 desires communication and data exchange with secondary device 24. At step 34, primary device 22 contacts device pairing server 20 via network 30 and requests a unique authentication code. At step 36, server 20 conveys this code to primary device 22 (source device preferably being pre-registered with website 10). At step 38, primary device 22 conveys the code to secondary device 24. At step 40, secondary device engages website 10, and conveys code thereby opening the conduit between the two devices, via server 20. In one aspect, data may be exchanged from primary device to server at 34, from secondary device to server at 40, from server to primary device at 36 and from server to secondary device at 42.

In further embodiments, third party data, content and services and “pointers” (44) are conveyed to and from server 20 (46 and 48) such data then enables to be transmitted to one or both of primary device 22 and secondary device 24. In further embodiments, third party data, content and services 44 are transmitted at 50 to primary device and at 52 to secondary. In further embodiments, additional data and content are transmitted at 54 from primary device to third party and at 56 from secondary device to third party. It is to be understood, as described fully herein, that conveyance between devices and device pairing server may direct to pointers and such pointers direct to third party content, data and services. As such, at 36, device pairing server may convey a pointer (received at 46) to primary device 22. In turn, primary device directs at 54 a request in accordance with such a pointer and to a third party device and 50 may represent data conveyed to primary device, such data located via pointer.

Similarly, at 42, device pairing server may convey a pointer (received at 46) to secondary device 24. In turn, secondary device directs at 56 a request in accordance with such a pointer and to a third party device and 52 may represent data conveyed to secondary device, such data located via pointer.

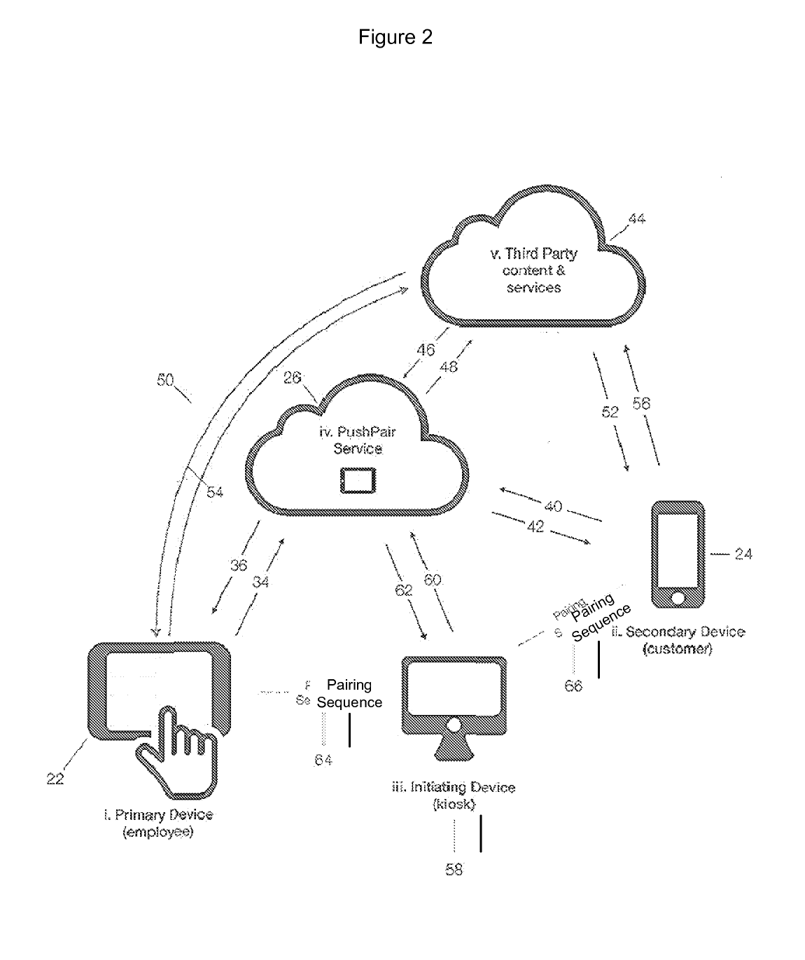

FIG. 2 represents a similar system to FIG. 1, with the introduction of an initiating device 58. This represents a pairing of primary device 22 and secondary device 24 by an authentication code i) requested by initiating device of device pairing server 26, at 60 and received back from device pairing server 26, at 62. Initiating device 58, in possession of authentication code, deliver such code to primary device at 64 and to secondary device at 66.

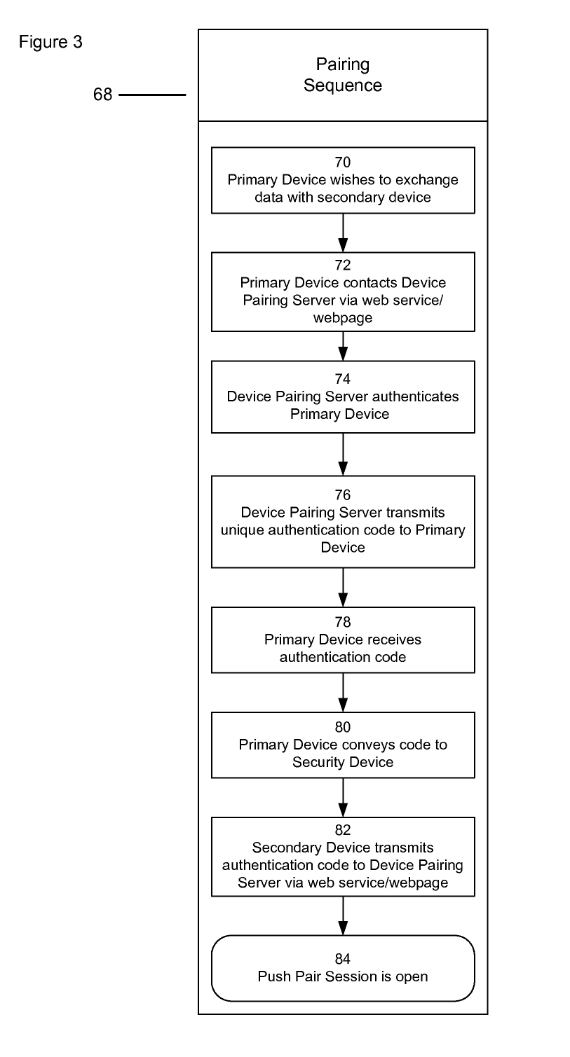

FIG. 3 represents a flow chart showing one type of pairing sequence generally at 68.
at 70, primary device (PD) wishes to engage secondary device
at 72, PD contacts device pairing server (DPS)
at 74 DPS authenticates PD
at 76 DPS sends authentication code to PD
at 78 PD receives code
at 80 PD conveys code to secondary device (SD)
at 82 SD transmits that code to DPS
at 84 “Push Pair” session is open

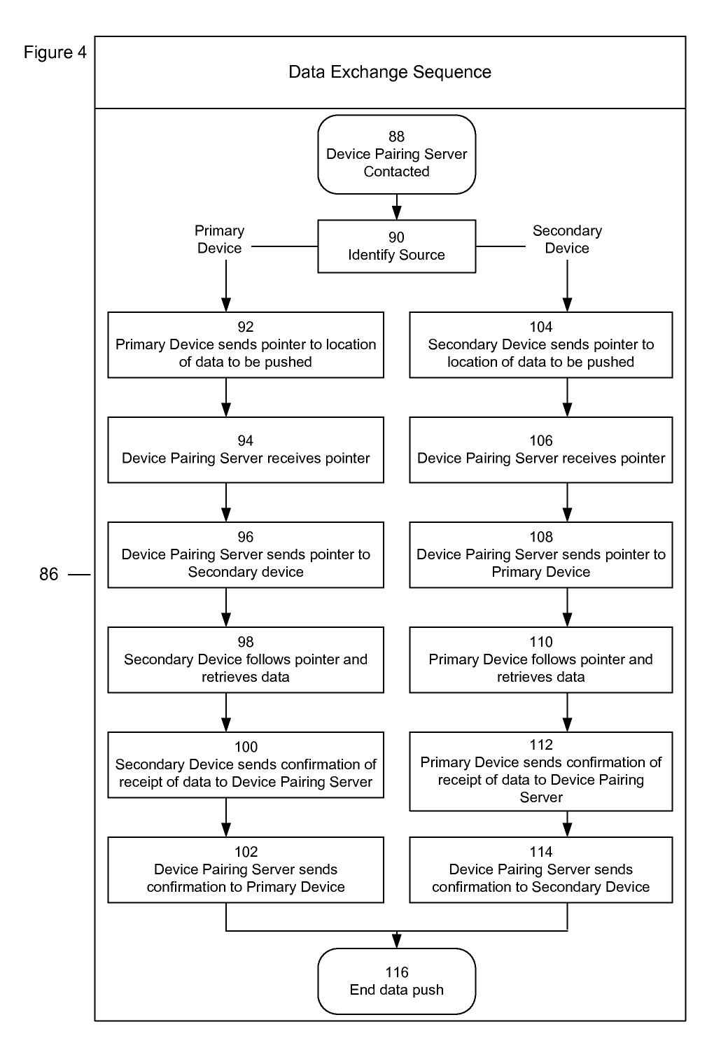

FIG. 4 represents a flow chart showing one type of data exchange sequence generally at 86 (occurring after pairing sequence 68) wherein:
DPS contacted 88
DPS identifies source of request 90
Primary device sends pointer of location of data to be pushed 92
DPS receives pointer 94
DPS sends pointer to SD 96
SD follows pointer and retrieves data 98
SD send confirmation to DPS that it has received data 100
DPS sends confirmation to PD of 100
Session sends at 166

FIG. 4 also represents a flow chart showing one type of data exchange sequence generally at 86 (occurring after pairing sequence 68) wherein:
DPS contacted 88
DPS identifies source of request 90
Secondary device sends pointer of location of data to be pushed 104
DPS receives pointer 106
DPS sends pointer to PD 108
PD follows pointer and retrieves data 110
PD send confirmation to DPS that it has received data 112
DPS sends confirmation to SD of 114
Session sends at 166

Preferred Additional Aspects of the Method and System
1) One to Many: Within the scope of the invention, a request is first made to the server by the Primary device, which receives an authentication or unique ID code. The primary device (or device pairing server) can then share this code not just with one secondary device but with multiple secondary devices. An example of this could be a Customer Sales Associate who is conducting a remote training session and needs to broadcast information to multiple SmartPhones simultaneously. Each user's interactions with their respective devices and with each other are their respective devices and with each other are managed by the server
2) Two way Interaction: The method and system of the present invention allows for both the primary and secondary devices to manipulate the content being shared through the use of asynchronous data transfer technologies to enable the pushing and pulling of data between devices. This results in the devices not only being able to send data to each other, but also being able to recall information that was previously sent.
3) Information Gathering and Authentication: to allow the primary device to capture information entered into the secondary device. This can include capturing an authentication from a third party social media account (for example, Facebook®, Twitter®) or this can include form fields that the user of the secondary device fills out on his device (for example, completing a questionnaire). The method and system of the present invention enables the primary device to capture this information and append it into other systems like CRMs. An example would be for a user of a primary device to request a user of the secondary device to follow the primary user on Twitter or other social media. The user of secondary device would receive a “follow” request, and once this is accepted, the secondary user's Twitter profile information can be pulled into the primary device. This could result in the primary device appending the user's profile picture and Twitter handle into a CRM program. This enhances future targeted marketing and business development efforts in regards to that secondary user. Furthermore, the method and system of the present invention enables commercial transactions to be completed, whereby the primary device can send a credit card authorization request to the secondary device, and the secondary device user can provide the authentication.
4) Data Manipulation: the method and system of the present invention is unique in that it can send raw data. Whenever this raw data is sent, another simultaneous request is made to the server to provide a “presentation template” so that the data can be formatted specifically for each secondary device. This allows the data to be dynamically displayed based on the device type and the nature of the data being sent. Most importantly, it allows users to actually manipulate this data on their respective devices.
5) Security: the method and system of the present invention is intended for secure communications, and as such, has SSL encryption built in to all its connections. The enables a customer service representative at a financial institution, for example, to provide temporary, secure access to specific pieces/modules of their internal systems to the secondary device. The method of the present invention also (optionally) wipes all data from secondary devices when the primary device terminates the connection.

### Uses:

The method and system of the present invention have wide-reaching commercial applications. These include, but are not limited to the following:

### Completing a Commercial Transaction

The method and system of the present invention can be used to facilitate a commercial transaction that involves an employee presenting offers (or other purchasable items) to a customer, guiding the customer through the options, and then having the customer select the desired offers, and then agree to purchase the offer on the customer's device.

### Customer Approval

The method and system of the present invention can be used in situations where an approval is required from one or more parties. For example, when a customer requests a series of changes to be made on her account, some of the changes may incur additional charges to the customer's monthly account, or may require additional consent. To approve these changes the employee initiates the protocols of the invention to engage devices with customer wherein the customer can review the important details associated with the changes, and then use a touch screen on his/her SmartPhone to sign with his/her finger and submit. This use case is highly advantageous in remote customer service scenarios where the customer is not easily able to sign a document on paper or in-store tablet device. In addition to signing/approving the agreement the customer can also request a copy of the document by selecting this option on their SmartPhone and entering the email address where the copy should be sent.

### Survey-Registration Tool

Employees can initiate the method and system of the present invention with a customer and request that she/he complete a survey or register for an account. After pairing the devices, the employee can send a series of questions to the customer and guide him/her through the questions. The customer can simultaneously answer the questions confidentially on his/her personal computing device (desktop or mobile).

### Secure Payload

The method and system of the present invention can be used to push down digital files to approved target devices. The digital files can include: calendar invites, software downloads, app updates, contact details, sensitive or encrypted data, etc. Payloads can also include component parts to other software such as single-use security tokens which can unlock application features or access sensitive information. The novelty of using the method and system of the present invention to deliver such secure payloads is that the authenticity of the source and target devices can be verified by real people in person. For example, before delivering a sensitive document to a customer, the employee can verify the identity of the customer by asking for photo ID using the secure data transmission protocols as described herein.

### Social Media

The method and system of the present invention can be used to facilitate sharing social media information between customers and employees whereby an employee requests the customer to share a particular piece of social media content. The method and system of the present invention allows the exchange between the employee and customer to be simple from the customer's perspective, since all he has to do is approve the social media content. Further, an employee may request a customer to approve the sharing of the customer's social media information (e.g. profile photo, personal details, friends, social media activities, etc. . . . ) with the employee. Once again, the method and system of the present invention allows the exchange to be simple from the customer's perspective because the employee is able to guide the customer through the process, each viewing the same material on their respective device interfaces.

### Customer Support

Customer support representatives at call centers often receive requests from customers having issues with various technical or account level problems. The method and system of the present invention allows the remote employees to visually guide the customer through the various details of their problem to reach a solution. For example, an airline customer contacts the call center to get the details surrounding their delayed flight. The employee initiates interaction with the secure server and implements the method of the invention with the customer and guides them to the updated flight information for their ticket, and even seat selection. The employee also pushes down a bookmark to the updated flight information website, and a link to the airlines app, so the customer can stay updated on any new information. This type of exchange saves the contacting the call center multiple times as flight schedules change.

### Medical, Legal Financial

In any business wherein sensitive information is to be conveyed between two or more parties on two or more devices, the present method and system can be used.

### Computer Systems

The systems and methods described herein rely on a variety of computer systems, networks and/or digital devices for operation. As will be appreciated by those skilled in the art, computing systems and web-based cross-platforms include non-transitory computer-readable storage media for tangibly storing computer readable instructions.

In one aspect, a computer system (or digital device), which may be understood as a logic apparatus adapted and configured to read instructions from media and/or network port, is connectable to a server and can have a fixed media. The computer system can also be connected to the Internet or an intranet. The system includes central processing unit (CPU), disk drives, optional input devices, such as a keyboard and/or mouse and optional monitor. Data communication can be achieved through, for example, communication medium to a server at a local or a remote location. The communication medium can include any suitable means of transmitting and/or receiving data. For example, the communication medium can be a network connection, a wireless connection or an Internet connection.

It is envisioned that data relating to the present disclosure can be transmitted over such networks or connections. The computer system can be adapted to communicate with a participant and/or a device used by a participant. The computer system is adaptable to communicate with other computers over the Internet, or with computers via a server. Each computing device (including mobile devices) includes an operating system (OS), which is software, that consists of software programs and data that runs on the devices, manages the device hardware resources, and provides common services for execution of various application software. The operating system enables an application program to run on the device.

As will be appreciated by those skilled in the art, a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

As will be appreciated by those of reasonable skill in the art, mobile devices as may be used in consumer communications can include a disparity of different, diverse and/or disparate portable devices including Tablet PC's, server class portable computing machines and/or databases, laptop computers, notebook computers, cell phones, smart phones, transportable handheld consumer appliances and/or instrumentation, portable industrial devices and/or components, personal digital assistants, multimedia Internet enabled phones, multimedia players, and the like.

Network topology and/or cloud can include any viable communication and/or broadcast technology, for example, wired and/or wireless modalities and/or technologies can be utilized to effectuate the claimed subject matter. Moreover, network topology and/or cloud can include utilization of Personal Area Networks (PANs), Local Area Networks (LANs), Campus Area Networks (CANs), Metropolitan Area Networks (MANs), extranets, intranets, the Internet, Wide Area Networks (WANs)—both centralized and/or distributed—and/or any combination, permutation, and/or aggregation thereof. Furthermore, as those skilled in the art will appreciate and understand various data communications protocols (e.g., TCP/IP, Ethernet, Asynchronous Transfer Mode (ATM), Fiber Distributed Data Interface (FDDI), Fibre Channel, Fast Ethernet, Gigabit Ethernet, Wi-Fi, Token Ring, Frame Relay, etc.) can be utilized to implement suitable data communications.

Additionally application delivery server/platform may include a provisioning component that, based at least in part on input received from a portal component, can automatically configure and/or provision the various disparate mobile devices with appropriate applications.

It is to be appreciated that a store can be, for example, volatile memory or non-volatile memory, or can include both volatile and non-volatile memory. By way of illustration, and not limitation, non-volatile memory can include read-only memory (ROM), programmable read only memory (PROM), electrically programmable read only memory (EPROM), electrically erasable programmable read only memory (EEPROM), or flash memory. Volatile memory can include random access memory (RAM), which can act as external cache memory. By way of illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink® DRAM (SLDRAM), Rambus® direct RAM (RDRAM), direct Rambus® dynamic RAM (DRDRAM) and Rambus® dynamic RAM (RDRAM). Store 206 of the subject systems and methods is intended to comprise, without being limited to, these and any other suitable types of memory. In addition, it is to be appreciated that the store can be a server, a database, a hard drive, and the like.

### Server Modules, Components, and Logic

Certain embodiments are described herein as including logic or a number of modules, components or mechanisms. A module, logic, component or mechanism (hereinafter collectively referred to as a “module”) may be a tangible unit capable of performing certain operations and is configured or arranged in a certain manner. In example embodiments, one or more computer systems (e.g. server computer system) or one or more components of a computer system (e.g., a processor or a group of processors) may be configured by software (e.g., an application or application portion) as a “module” that operates to perform certain operations as described herein.

In various embodiments, a “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations.

Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation, and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The invention can be implemented in numerous ways, including as a process, an apparatus, a system, a computer readable medium such as a computer readable storage medium or a computer network wherein program instructions are sent over optical or communication links. In this specification, these implementations, or any other form that the invention may take, may be referred to as systems or techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

The following discussion provides a brief and general description of a suitable computing environment in which various embodiments of the system may be implemented. Although not required, embodiments will be described in the general context of computer-executable instructions, such as program applications, modules, objects or macros being executed by a computer. Those skilled in the relevant art will appreciate that the invention can be practiced with other computing system configurations, including hand-held devices, multiprocessor systems, microprocessor-based or programmable consumer electronics, personal computers (“PCs”), network PCs, mini-computers, mainframe computers, mobile phones, personal digital assistants, smart phones, personal music players (like iPod) and the like. The embodiments can be practiced in distributed computing environments where tasks or modules are performed by remote processing devices, which are linked through a communications network. In a distributed computing environment, program modules may be located in both local and remote memory storage devices.

As used herein, the terms “computer” and “server” are both computing systems as described in the following. A computing system may be used as a server including one or more processing units, system memories, and system buses that couple various system components including system memory to a processing unit. Computing system will at times be referred to in the singular herein, but this is not intended to limit the application to a single computing system since in typical embodiments, there will be more than one computing system or other device involved. Other computing systems may be employed, such as conventional and personal computers, where the size or scale of the system allows. The processing unit may be any logic processing unit, such as one or more central processing units (“CPUs”), digital signal processors (“DSPs”), application-specific integrated circuits (“ASICs”), etc. Unless described otherwise, the construction and operation of the various components are of conventional design. As a result, such components need not be described in further detail herein, as they will be understood by those skilled in the relevant art.

The computing system includes a system bus that can employ any known bus structures or architectures, including a memory bus with memory controller, a peripheral bus, and a local bus. The system also will have a memory which may include read-only memory (“ROM”) and random access memory (“RAM”). A basic input/output system (“BIOS”), which can form part of the ROM, contains basic routines that help transfer information between elements within the computing system, such as during startup.

The computing system also includes non-volatile memory. The non-volatile memory may take a variety of forms, for example a hard disk drive for reading from and writing to a hard disk, and an optical disk drive and a magnetic disk drive for reading from and writing to removable optical disks and magnetic disks, respectively. The optical disk can be a CD-ROM, while the magnetic disk can be a magnetic floppy disk or diskette. The hard disk drive, optical disk drive and magnetic disk drive communicate with the processing unit via the system bus. The hard disk drive, optical disk drive and magnetic disk drive may include appropriate interfaces or controllers coupled between such drives and the system bus, as is known by those skilled in the relevant art. The drives, and their associated computer-readable media, provide non-volatile storage of computer readable instructions, data structures, program modules and other data for the computing system. Although computing systems may employ hard disks, optical disks and/or magnetic disks, those skilled in the relevant art will appreciate that other types of non-volatile computer-readable media that can store data accessible by a computer may be employed, such a magnetic cassettes, flash memory cards, digital video disks (“DVD”), Bernoulli cartridges, RAMs, ROMs, smart cards, etc.

Various program modules or application programs and/or data can be stored in the system memory. For example, the system memory may store an operating system, end user application interfaces, server applications, and one or more application program interfaces (“APIs”).

The system memory also includes one or more networking applications, for example a Web server application and/or Web client or browser application for permitting the computing system to exchange data with sources, such as clients operated by users and members via the Internet, corporate Intranets, or other networks as described below, as well as with other server applications on servers such as those further discussed below. The networking application in the preferred embodiment is markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available, such as those available from Mozilla and Microsoft.

The operating system and various applications/modules and/or data can be stored on the hard disk of the hard disk drive, the optical disk of the optical disk drive and/or the magnetic disk of the magnetic disk drive.

A computing system can operate in a networked environment using logical connections to one or more client computing systems and/or one or more database systems, such as one or more remote computers or networks. The computing system may be logically connected to one or more client computing systems and/or database systems under any known method of permitting computers to communicate, for example through a network such as a local area network (“LAN”) and/or a wide area network (“WAN”) including, for example, the Internet. Such networking environments are well known including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, the computing system is connected to the LAN through an adapter or network interface card (communicatively linked to the system bus). When used in a WAN networking environment, the computing system may include an interface and modem (not shown) or other device, such as a network interface card, for establishing communications over the WAN/Internet.

In a networked environment, program modules, application programs, or data, or portions thereof, can be stored in the computing system for provision to the networked computers. In one embodiment, the computing system is communicatively linked through a network with TCP/IP middle layer network protocols; however, other similar network protocol layers are used in other embodiments, such as user datagram protocol (“UDP”). Those skilled in the relevant art will readily recognize that these network connections are only some examples of establishing communications links between computers, and other links may be used, including wireless links.

While in most instances the computing system will operate automatically, where an end user application interface is provided, an operator can enter commands and information into the computing system through an end user application interface including input devices, such as a keyboard, and a pointing device, such as a mouse. Other input devices can include a microphone, touchscreen, joystick, scanner, etc. These and other input devices are connected to the processing unit through the end user application interface, such as a serial port interface that couples to the system bus, although other interfaces, such as a parallel port, a game port, or a wireless interface, or a universal serial bus (“USB”) can be used. A monitor or other display device is coupled to the bus via a video interface, such as a video adapter (not shown). The computing system can include other output devices, such as speakers, printers, etc.

The present methods, systems and articles also may be implemented as a computer program product that comprises a computer program mechanism embedded in a computer readable storage medium. For instance, the computer program product could contain program modules. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and/or processes via the use of examples. Insofar as such examples contain one or more functions and/or operations, it will be understood by those skilled in the art that each function and/or operation within such examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

Further, in the methods taught herein, the various acts may be performed in a different order than that illustrated and described. Additionally, the methods can omit some acts, and/or employ additional acts. As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

While certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

### Example

An illustration of how a device pairing server can be used to seamlessly push content and cause interaction between two devices. It is important to notice that both devices are connected on different networks. An iPad is using a Wi-Fi connection, while an iPhone is on a 3G cellular network.

In this example, there is a sales associate at a communication service provider's retail store interacting with a customer
Sales Associate has an iPad
Customer uses an iPhone

Customer walking into the store to discuss his account. The sales associate pulls up the customer's account information. He then asks the customer to connect to his iPad to get guided information on the account and to participate in making changes to it. The sales associate directs the customer to go to a device pairing website (www.pushpair.com). Alternatively, sales associate could do a QR code scan, or NFC tap of customer's device.

The Customer then logs in on his phone using the generated access number, which creates a bank-grade secure connection. The Sales Associate now begins to push over information which might include Customer Profile information and usage data. The customer can now easily see where he has gone over his usage limits. The Sales Associate can then offer add-ons or promotions for the customer's account.

This is an example of the seamless transfer of information that the device pairing sever enables across various networks and platforms.

Within the scope of the invention, there can be two-way interaction where both the sales associate and customer can control the information during the session. As well, the sales associate can send and recall information on the customer's device. Also, social media platforms can be integrated to engage the customer and build valuable customers relationship information. For example, the sales associate can request the customer to follow the retailer on Twitter. Finally, once the session is finished, the Sales Associate can wipe the customer's screen of all sensitive information and terminate the connection.

We claim:

1. A computer-implemented method of pairing at least two micro-processing devices (a primary device on a first network and a secondary device on a second network which may be different from the first network) via a device pairing server for the purpose of at least one of i) direct data exchange and ii) indirect data exchange, between the devices, which comprises a) the primary device, desiring one of i) direct data exchange and ii) indirect data exchange with the secondary device, acquiring a first authentication code; b) the secondary device, desiring one of i) direct data exchange and ii) indirect data exchange with the primary device acquiring a second authentication code; c) the primary device and the secondary device using respective authentication codes, which may be the same, to access at least one of a web site, web-service, mobile application of the device pairing server and upon entering respective authentication codes linking the primary device with the secondary device via the device pairing server; wherein authentication codes are requested, acquired and exchanged by at least one of the following arrangements:
i. primary device acquires authentication code from the device pairing server and transmits authentication code to secondary device;
ii. secondary device acquires authentication code from the device pairing server and transmits authentication code to primary device;
iii. both primary device and secondary device acquire the same authentication code from the device pairing server;
iv. the primary device acquires the authentication code from a third device which is recognized by the device pairing server and transmits authentication code to secondary device;
v. the secondary device acquires the authentication code from a third device which is recognized by the device pairing server and transmits authentication code to primary device; and
vi. both primary device and secondary device acquire the same authentication code from a third device which is recognized by the device pairing server.

2. The method of claim 1 wherein direct data exchange comprises at least one of: the step of device pairing service receiving data from primary device and transmitting such data to secondary device, and the step of device pairing service receiving data from secondary device and transmitting such data to primary device.

3. The method of claim 1 wherein indirect data exchange comprises at least one of:
a) the step of device pairing server receiving, from the primary device a pointer and transmitting said pointer to the secondary device, the pointer representing at least one of:
i. third party content which is downloaded by the secondary device;
ii. content on the device pairing server which is downloaded by the secondary device; and
iii. third party content populating a template on the device paring server, which is downloaded by the secondary device; and
b) the step of device pairing server receiving, from the secondary device a pointer and transmitting said pointer to the primary device, the pointer representing at least one of:
i) third party content which is downloaded by the primary device;
ii) content on the device pairing server which is downloaded by the primary device; and
iii) third party content populating a template on the device pairing server, which is downloaded by the primary device.

4. A computer-implemented method of pairing at least two micro-processing devices (a primary device on a first network and a secondary device on a second network which may be different from the first network) via a device pairing server for the purpose of data exchange, which comprises a) the primary device, desiring data exchange with the secondary device, acquiring a first authentication code; b) the secondary device, desiring data exchange with the primary device acquiring a second authentication code; c) the primary device and the secondary device using respective authentication codes to access at least one of a web site or web-service of the device pairing server and upon entering respective authentication codes linking the primary device with the secondary device via the device pairing server; wherein both the primary device and the secondary device acquire respective authentication codes from a third device which is recognized by the device pairing server.

5. A computer-implemented method of pairing at least two micro-processing devices (a primary device on a first network and a secondary device on a second network which may be different from the first network) for the purpose of data exchange, which comprises a) the primary device, desiring data exchange with the secondary device, requesting from a device pairing server an authentication code; b) the primary device receiving the authentication code and conveying the authentication code to the secondary device; the secondary device accessing a web service or an web-based interface of the device pairing server and entering the authentication code, therein linking the primary device with the secondary device via the device pairing server; c) the primary device and the secondary device accessing and sharing data through at least one direct data exchange and indirect data exchange.

6. The computer-implemented method of claim 1 wherein the code is conveyed to the secondary device by a means selected from the group consisting of: i) a user of secondary device entering such code into the target device via a user interface (for example a touchscreen or keyboard on the secondary device); ii) via email messaging; iii) via SMS; iv) via push messaging; ii) optical scanning (for example, scanning a QR code); iii) proximity based technologies like near field communications (NFC); iv) infrared signaling; v) audible signalling vi) wireless/radio signaling; vii) light signaling; viii) electro-magnetic signaling; and ix) any networked conveyance.

7. The computer-implemented method of claim 1 wherein the data exchange relates to mobile commerce transactions.

8. The computer-implemented method of claim 1 wherein the data exchange relates to customer care and management.

9. The computer-implemented method of claim 1 wherein the data exchange relates to media sharing.

10. The computer-implemented method of claim 1 wherein the authentication code is received by the primary device and shared with more than one secondary device.

11. The computer-implemented method of claim 1 wherein the data is transmitted asynchronously.

12. The computer-implemented method of claim 1 additionally comprising the step of recalling data transmitted directly or indirectly between the primary device and the secondary device.

13. The computer-implemented method of claim 1 wherein data transmitted comprises social media authentications for a user of one of the secondary device and the primary device.

14. The computer-implemented method of claim 1 wherein data transmitted comprises form fields to be completed by a user of one of the secondary device and the primary device.

15. The computer-implemented method of claim 1 wherein data transmitted comprises a credit card payment authorization.

16. The computer-implemented method of claim 1 additionally comprising, when data is to be transferred in raw form, the step of the primary device requesting a presentation template to format the raw data for display on the secondary device.

17. The computer-implemented method of claim 16 wherein said raw data may be manipulated by users of the primary device and the secondary device by way of the presentation template.

18. The computer-implemented method of claim 1 wherein the device pairing server facilitates at least one of a controlled, limited purpose direct data exchange between the primary device and the secondary device and an indirect data exchange between the primary device and the secondary device and thereafter directs deletion and removal of all data transferred between the primary device to the secondary device at the completion of the exchange.

19. The computer-implemented method of claim 1 wherein the device pairing server encrypts all data.

20. The computer-implemented method of claim 1 wherein the device pairing server facilitates a controlled, limited purpose data exchange between and among a plurality of devices.

21. The computer-implemented method of claim 1 wherein at least one of the primary device and secondary device is at least one of a desktop computer, laptop computer, personal digital assistant, a SmartPhone other cellular phone, and a tablet.

22. The computer-implemented method of claim 1 wherein at least one of the primary device and the secondary device is at least one of an iPhone, iPAD, Apple computer or other device operating via iOS or MAC operating systems, and device operating on Android operating systems.

23. A non-transitory processor readable medium storing code representing instructions to cause a processor to pair at least two micro-processing devices (a primary device on a first network and a secondary device on a second network which is different from the first network) for the purpose of data exchange, said pairing comprising a primary device on a first network and a secondary device on a second network (which may be different from the first network) via a device pairing server for the purpose of data exchange, which comprises a) the primary device, desiring data exchange with the secondary device, acquiring a first authentication code; b) the secondary device, desiring data exchange with the primary device acquiring a second authentication code; c) the primary device and the secondary device using respective authentication codes to access at least one of a web site, web-service and mobile application of the device pairing server and upon entering respective authentication codes linking the primary device with the secondary device via the device pairing server; wherein at least one of the primary device and the secondary device acquires respective authentication code from a third device which is recognized by the device pairing server; and d) the primary device and the secondary device accessing and sharing data through at least one of direct data exchange and indirect data exchange.

24. A non-transitory processor readable medium storing code representing instructions to cause a processor to pair at least two micro-processing devices (a primary device on a first network and a secondary device on a second network which is different from the first network) for the purpose of data exchange, said pairing comprising a) the primary device, desiring data exchange with the secondary device, requesting from a device pairing server an authentication code; b) the primary device receiving the authentication code and conveying the authentication code to the secondary device; the secondary device accessing a web service or an web-based interface of the device pairing server and entering the authentication code, therein linking the primary device with the secondary device via the device pairing server; c) the primary device and the secondary device accessing and sharing data through at least one of direct data exchange and indirect data exchange.

25. A system comprising:
a) a primary micro-processing device (primary device) at a first location and connected to the internet via a first network, said primary device being desirous of at least one of i) synchronously and/or asynchronously transmitting audio and/or video and/or other data and content to a secondary micro-processing device and ii) synchronously and/or asynchronously transmitting a pointer to the secondary device, said pointer representing at least one of: third party content which is downloaded by the secondary device; content on the device pairing server which is downloadable by the secondary device and third party content populating a template on a device pairing server, which is downloadable by the secondary device;
b) the secondary micro-processing device (secondary device) at a second location, which may be the same at the first location, and connected to the internet via a second network which may be different from the first network, said secondary device being desirous of at least one of i) synchronously and/or asynchronously transmitting audio and/or video and/or other data and content to the primary micro-processing device and ii) synchronously and/or asynchronously transmitting a pointer to the primary device, said pointer representing at least one of: third party content which is downloadable by the primary device; content on the device pairing server which is downloadable by the primary device and third party content populating a template on a device pairing server, which is downloadable by the primary device; and
c) the device pairing server comprising a processor configured: i) in response to a request from an initiating device, to generate an authentication code ii) to receive input of such authentication code from a primary device and secondary device via at least one of a web site, web service or mobile application interface, wherein said primary device and secondary device acquires the authentication code from the initiating device and iii) to undertake at least one of the following actions: acting as a data exchange conduit between the primary device and the secondary device after input of authentication code from the primary device and the secondary device and verification of each authentication code; acting as a conduit between the primary device and the secondary device after input of authentication code from the primary device and the secondary device and verification of each authentication code in order to convey a pointer from at least one of primary device to secondary device and secondary device to primary device, wherein said pointer represents at least one of: third party content which is downloadable by/accessible to a device; content on the device pairing server which is downloadable by/accessible to a device and third party content populating a template on a device pairing server, which is downloadable by/accessible to a device; defining the parameters of the secure communications between the primary device and the secondary device; accessing and sharing data between the primary device and the secondary device through at least one direct data exchange and indirect data exchange; recalling data sent to the secondary device; recalling data sent to the primary device; recording details of pairing sessions between the primary device the secondary device; tracking requests made by the primary device and the secondary device; managing the transmission of third party media to the primary device and to the secondary device; controlling primary device relative to the secondary device; and controlling secondary device relative to the primary device and controlling security of data exchanged between the primary device and the secondary device.

26. A device pairing server comprising a processor configured: i) in response to a request from an initiating device, to generate an authentication code ii) to receive input of such authentication code from a primary device and secondary device via at least one of a web site, web service or mobile application interface, wherein said primary device and secondary device acquire the authentication code from the initiating device and iii) to undertake at least one of the following actions: acting as a data exchange conduit between the primary device and the secondary device after input of authentication code from the primary device and the secondary device and verification of each authentication code; acting as a conduit between the primary device and the secondary device after input of authentication code from the primary device and the secondary device and verification of each authentication code in order to convey a pointer from at least one of primary device to secondary device and secondary device to primary device, wherein said pointer represents at least one of: third party content which is downloadable by/accessible to a device; content on the device pairing server which is downloadable by/accessible to a device and third party content populating a template on a device pairing server, which is downloadable by/accessible to a device; defining the parameters of the secure communications between the primary device and the secondary device; accessing and sharing data between the primary device and the secondary device through at least one direct data exchange and indirect data exchange; recalling data sent to the secondary device; recalling data sent to the primary device; recording details of pairing sessions between the primary device the secondary device; tracking requests made by the primary device and the secondary device; managing the transmission of third party media to the primary device and to the secondary device; controlling primary device relative to the secondary device; and controlling secondary device relative to the primary device and controlling security of data exchanged between the primary device and the secondary device.
